(19) United States
(12) Patent Application Publication
(10) Pub. No.: US 2022/0121081 A1
(43) Pub. Date: Apr. 21, 2022

(54) Micro Magneto-optical Fiber Switch

(71) Applicant: ZHEJIANG UNIVERSITY, Hangzhou (CN)

(72) Inventors: Xiaofeng Jin, Hangzhou (CN); Huilong Chen, Hangzhou (CN)

(21) Appl. No.: 17/561,751

(22) Filed: Dec. 24, 2021

Related U.S. Application Data
(63) Continuation of application No. PCT/CN2020/104979, filed on Jul. 27, 2020.

(30) Foreign Application Priority Data
Aug. 7, 2019 (CN) 201910725636.5

(51) Int. Cl. G02F 1/313

(52) U.S. Cl. CPC G02F 1/313

(57) ABSTRACT

Provided is a miniature magneto-optical fiber switch. The miniature magneto-optical fiber switch includes a miniature three-fiber collimator, a miniature current coil, and a miniature space optical processing optical core. The miniature magneto-optical optical fiber switch realizes a 1×2 optical fiber switch structure and a 2×1 optical fiber switch structure by controlling the current direction of the coil.

### CROSS-REFERENCE TO RELATED APPLICATIONS

This application is the US National Phase of International Patent Application No. PCT/CN2020/104979, filed on Jul. 27, 2020, entitled “Miniature Magneto-optical Fiber Switch,” which claims foreign priority of China Patent Application No. 201910725636.5, filed Aug. 7, 2019 in the China National Intellectual Property Administration, the entire contents of which are hereby incorporated by reference in their entireties.

### TECHNICAL FIELD

The present disclosure relates to the technical field of optics and optical fiber communication, and in particularly to a miniature magneto-optical fiber switch.

### BACKGROUND

Fiber switches are optical devices used in an optical system to switch between one or more input fiber ports and one or more output ports. Fiber switches are used in fiber communication systems to connect and disconnect the information-loaded transmission optical channel which provides functions such as network protection, link cross-connection and add/drop multiplexing. Fiber switches can also be used to make light sources generate pulsed optical signals, such as lasers or use optical fiber switches to modulate to load information or cut off optical fiber paths to realize its related functions.

A simple type of fiber switch is a 1×2 fiber switch that can provide optical switching between one input port and two output ports, or a 2×1 fiber switch provides optical switching between two input ports and one output port. The 1×2 or 2×1 fiber switches using optical refraction and reflection are pretty reliable with small insertion loss and easy for manufacturing. The 1×2 or 2×1 fiber switches have been widely used in the radio communication industry, such as protection switching, mark switching, or the like. The 1×2 fiber optic switches have also been used to build large-size switches, such as 1×4 and 1×8 fiber switches. In some cases, using several 1×2 fiber switches to construct 1×4 and 1×8 fiber switches can reduce manufacturing complexity, or reduce energy consumption or reduce physical space occupied.

There are many technologies to realize these optical switches, such as mechanical optical switches, MEMS switches, thermo-optical switches, liquid crystal optical switches, magneto-optical switches, acousto-optic switches, and semiconductor electro-optical switches. Each switching technology has its own characteristics. For example, mechanical optical switches are currently the most widely used optical fiber port switching devices. It has very small insertion loss and crosstalk characteristics, but its switching time is limited to milliseconds, and the device itself is large. Other products using MEMS optical switches, thermo-optical switches and liquid crystal optical switches have a relatively slow switching response speed (milliseconds). The fiber switching speed realized by magneto-optical technology and acousto-optic technology can be ranged in tens of microseconds to hundreds of microseconds. While the semiconductor electro-optical switching speed can reach the class of nanoseconds, there are defects such as polarization dependence and large waveguide coupling loss.

### SUMMARY

The magneto-optical switch is a switching technology of optical channel realized by using magnetic field to generate a polarized light Faraday rotation. By controlling the direction of the magnetic field, the direction of rotation of the magneto-optical crystal is controlled forward and reverse to realize the guidance path switching of single or multiple fiber ports. Compared with the prior art, the present disclosure provides a miniature magneto-optical fiber switch comprising a miniature three-fiber collimator, a miniature current coil, and a miniature spatial optical processing optical core. The miniature magneto-optical optical fiber switch realizes the switching of the optical fiber port path of various structures such as 1×2 structure and 2×1 structure by controlling the current direction of the current coil.

The miniature magneto-optical fiber switch comprises a miniature three-fiber collimator, a miniature current coil, and a miniature space optical processing optical core. The miniature magneto-optical optical fiber switch realizes a 1×2 optical fiber switch structure and a 2×1 optical fiber switch structure by controlling the current direction of the coil.

The miniature three-fiber collimator is assembled by bonding a three-hole capillary tube, three single-mode fibers and a collimating microlens through a micro-optics process. The three holes of the three-hole capillary tube are uniformly arranged in a line. The three single-mode fibers are respectively placed in the three-hole capillary tube, and spacings between the three single-mode fibers are uniform. The collimating microlens collimates the input light of the three single-mode fibers into three directions in space, and realizes the even collimated spatial light angle of the three single-mode fibers in the miniature three-fiber collimator through micro-optics adjustment and bonding assembly.

The miniature current coil generates a spatial saturation magnetic field under the action of current, and the spatial orientation of the magnetic field is parallel to the axis of the coil.

The micro spatial light processing optical core is assembled by a first polarization beam splitting prism, a wave plate, a magneto-optical crystal, and a second polarization beam splitting prism through micro-optical bonding. The first polarization beam splitting prism sequentially comprises a first total reflection surface, a polarization beam splitting surface, a second total reflection surface, and a third total reflection surface. The second polarization beam splitting prism sequentially comprises a first total reflection surface, a polarization beam splitting surface, and a second total reflection surface. The wave plate combined with the magneto-optical crystal is used to change the polarization state of the beam.

The optical axis orientation of the wave plate is 22.5° with the horizontal direction of the light transmission tangent plane, thereby realizing a 45° rotation of the input horizontally polarized light and a 135° polarization rotation of the input vertical polarized light. Alternatively, the optical axis orientation of the wave plate is 22.5° to the vertical direction of the light transmission tangent plane, thereby realizing a 45° rotation of the input vertically polarized light and a 135° polarization rotation of the input horizontally polarized light.

The magneto-optical crystal is a Faraday rotator crystal with an coercive force of the internal magnetic field. The direction of the coercive force of the internal magnetic field is parallel to the direction of the spatial saturation magnetic field generated by the miniature current coil. The coercive force of the internal magnetic field of the magneto-optical crystal makes the input linearly polarized light produce a polarization state of 45° or −45°, and the direction of the coercive force of the internal magnetic field is parallel to the light transmission direction.

Under the spatial saturation magnetic field generated by the miniature current coil, when the direction of the magnetic field is opposite to the direction of the coercive force, the coercive force of the internal magnetic field of the magneto-optical crystal will be reversed. The reversal of the coercive force causes the direction of the Faraday rotation to be reversed. That is, the Faraday rotation angle of linearly polarized light is changed from 45° to −45° or from −45° to 45°.

In some embodiments, the miniature magneto-optical fiber switch realizes the switching of the direction of the spatial saturation magnetic field by changing the direction of the coil current, and then controls the forward and reverse of the rotation direction of the magneto-optical crystal to realize the switching of the light beam conduction channel at different fiber ports.

In some embodiments, the specific optical path of the micro-magneto-optical fiber switch with a 1×2 fiber-optic switch structure is realized as: when the magnetic field generated by the current control coil makes the polarization direction generated by the magneto-optical crystal rotating 45° clockwise (that is, forward+45°), the collimating microlens collimates the light from the second single-mode fiber into a parallel beam, which passes through the second total reflection surface of the first polarization beam splitting prism, the third total reflection surface of the first polarization beam splitting prism, and the first polarization beam splitting prism in turn. The second total reflection surface of the two polarization beam splitting prism reaches the polarization beam splitting surface of the second polarization beam splitting prism after reflection. The fully polarized light beam is divided into two light beams with mutually perpendicular polarization states after passing through the polarization beam splitting surface, that is, the normal light beam and the abnormal light beam. The polarization direction of the normal light beam is along the vertical y-axis direction, and the polarization direction of the abnormal light beam is along the horizontal x-axis direction. The normal beam reaches the magneto-optical crystal after being reflected by the polarization splitting surface of the second polarization beam splitting prism for 90 degrees. After the polarization direction of the magneto-optical crystal is rotated by +45°, the polarization direction of the wave plate is rotated clockwise by 45°, and the polarization direction of the normal beam is changed to the horizontal x-axis direction. The abnormal light beam is transmitted through the polarization beam splitting surface of the second polarization beam splitting prism and reflected by the first total reflection surface of the second polarization beam splitting prism to reach the magneto-optical crystal. The polarization direction is rotated 45° clockwise, and the polarization state of the abnormal beam becomes vertical to the y-axis direction. The normal light beam passing through the wave plate is reflected by the second total reflection surface of the first polarization beam splitting prism and reaches the polarization beam splitting surface of the first polarization beam splitting prism, which becomes an abnormal beam relative to the polarization beam splitting surface of the first polarization beam splitting prism. However, the abnormal light beam passing through the wave plate reaches the first polarization beam splitting prism, and it becomes a normal beam relative to the polarization beam splitting surface of the first polarization beam splitting prism. The polarization beam splitting surface of the first polarization beam splitting prism combines the two beams into one beam, and the combined beam passes through the first total reflection surface of the first polarization beam splitting prism and is received and output by the first single-mode fiber in the micro three-fiber collimator.

When the magnetic field generated by the current control coil makes the polarization direction generated by the magneto-optical crystal rotate 45° counterclockwise (that is, reverse −45°), the collimating microlens collimates the light from the second single-mode fiber into a parallel beam, After being reflected by the second total reflection surface of the first polarization beam splitting prism, the third total reflection surface of the first polarization beam splitting prism, and the second total reflection surface of the second polarization beam splitting prism in turn, it reaches the polarization beam splitting surface of the second polarization beam splitting prism . The fully polarized light beam is divided into two light beams with mutually perpendicular polarization states after passing through the polarization beam splitting surface, that is, the normal light beam and the abnormal light beam. The polarization direction of the normal light beam is along the vertical y-axis direction, and the polarization direction of the abnormal light beam is along the horizontal x-axis direction. The normal beam reaches the magneto-optical crystal after being reflected by the polarization splitting surface of the second polarization beam splitting prism for 90 degrees. After the polarization direction of the magneto-optical crystal is rotated by −45°, the polarization direction of the wave plate is rotated clockwise by 45°. The polarization state of the normal beam is There is no change, and the polarization direction is still along the vertical y-axis. The abnormal light beam is transmitted through the polarization beam splitting surface of the second polarization beam splitting prism and reflected by the first total reflection surface of the second polarization beam splitting prism to reach the magneto-optical crystal. The polarization direction is rotated 45° clockwise, and the polarization state of the abnormal beam remains unchanged, and its polarization direction is still along the horizontal x-axis direction. The normal light beam passing through the wave plate is reflected by the second total reflection surface of the first polarization beam splitting prism and reaches the polarization beam splitting surface of the first polarization beam splitting prism. The abnormal beam output by the wave plate is polarized and combined on the polarization beam splitting surface, and the polarization beam is split. The two beams are polarized and combined into one beam, and the combined beam is received and output by the third single-mode fiber of the miniature three-fiber collimator.

By controlling the current direction of the coil, the Faraday rotation direction of the magneto-optical crystal can be switched forward or reverse, and then the second single-mode fiber in the micro three-fiber collimator can be selectively input to the first single-mode fiber output or the second single-mode fiber output. Switching between the input of the mode fiber and the output of the third single mode fiber, thereby realizing a 1×2 fiber switch structure.

In some embodiments, the specific optical path of the miniature magneto-optical fiber switch with a 2×1 fiber switch structure is realized as: when the magnetic field generated by the current control coil makes the polarization direction generated by the magneto-optical crystal rotate 45° counterclockwise (that is, reverse −45°)°), the collimating microlens collimates the light from the first single-mode fiber into a parallel beam, which is reflected by the first total reflection surface of the first polarization beam splitting prism and reaches the polarization beam splitting surface of the first polarization beam splitting prism. The polarized light beam is divided into two light beams with mutually perpendicular polarization states after passing through the polarization beam splitting surface, that is, the normal light beam and the abnormal light beam. The polarization direction of the normal light beam is along the vertical y-axis direction, and the polarization direction of the abnormal light beam is along the horizontal x-axis direction. The normal light beam is reflected by the polarization beam splitting surface of the second polarization beam splitting prism and reaches the wave plate. After the polarization direction of the wave plate is rotated 45° counterclockwise, the polarization direction of the magneto-optical crystal is rotated −45°, and the polarization direction of the normal light beam becomes horizontal. x-axis direction. Then, the normal light beam is reflected by the first total reflection surface of the second polarization beam splitting prism and then reaches the polarization beam splitting surface of the second polarization beam splitting prism. Anomalous light beams are transmitted through the polarization beam splitting surface of the second polarization beam splitting prism in turn, and then reflected by the second total reflection surface of the first polarization beam splitting prism to reach the wave plate. The polarization direction of the crystal is rotated −45°, and the polarization state of the abnormal beam becomes perpendicular to the y-axis direction and reaches the polarization splitting surface of the second polarization splitting prism. The polarization beam splitting surface of the second polarization beam splitting prism combines the two beams into one beam. The combined beam is sequentially reflected by the second total reflection surface of the second polarization beam splitting prism, the third total reflection surface of the first polarization beam splitting prism, and the second total reflection surface of the first polarization beam splitting prism, and is received and outputted by the second single-mode fiber in the miniature three-fiber collimator.

When the magnetic field generated by the current control coil makes the polarization direction generated by the magneto-optical crystal rotate 45° clockwise (that is, forward +45°), the collimating microlens collimates the light from the third single-mode fiber into a parallel beam, When incident on the polarization beam splitting surface of the first polarization beam splitting prism, the fully polarized light beam passes through the polarization beam splitting surface and is divided into two beams with mutually perpendicular polarization states, namely, the normal beam and the abnormal beam. The polarization direction of the normal light beam is along the vertical y-axis direction, and the polarization direction of the abnormal light beam is along the horizontal x-axis direction. The normal light beam is reflected by the polarization beam splitting surface of the first polarization beam splitting prism and the second total reflection surface of the first polarization beam splitting prism in turn, and then reaches the wave plate. When the direction is rotated by +45°, the polarization state of the normal beam remains unchanged, and the polarization direction is still along the vertical y-axis. Then, the normal light beam reaches the polarization splitting surface of the second polarization splitting prism. The abnormal beam passes through the polarization splitting surface of the first polarization beam splitting prism and reaches the wave plate, and then the polarization direction of the wave plate is rotated 45° counterclockwise, and then the polarization direction of the magneto-optical crystal is rotated +45°. The polarization state of the abnormal beam remains unchanged. Its polarization direction is still along the horizontal x-axis direction. Then, the returning beam is reflected by the first total reflection surface of the second polarization beam splitting prism and then reaches the polarization beam splitting surface of the second polarization beam splitting prism. The polarization beam splitting surface of the second polarization beam splitting prism combines the two beams into one beam. The combined beams are sequentially reflected by the second total reflection surface of the second polarization beam splitting prism, the third total reflection surface of the first polarization beam splitting prism, and the second total reflection surface of the first polarization beam splitting prism, and are received and outputted by the second single-mode fiber in the miniature three-fiber collimator.

By controlling the current direction of the coil, the Faraday rotation of the magneto-optical crystal can be switched forward or reverse, and then the third single-mode fiber or the first single-mode fiber in the miniature three-fiber collimator can be selectively switched, thereby realizing a 2×1 fiber switch structure.

In some embodiments, when the direction of the magnetic field generated by the current control coil makes the polarization direction generated by the magneto-optical crystal rotate 45° counterclockwise, it corresponds to the polarization rotation of +45° and −45° generated by the two optical transmission directions in the wave plate. Elimination and superposition, so as to realize the circular optical path conduction mode of the micro three-fiber collimator from the first single-mode fiber input to the second single-mode fiber output, and from the second single-mode fiber input to the third single-mode fiber output.

When the direction of the magnetic field generated by the current control coil makes the polarization direction generated by the magneto-optical crystal rotate 45° clockwise, it overlaps and cancels the polarization rotation +45° and −45° generated by the two light transmission directions in the wave plate. Therefore, the circular optical path conduction mode in which the third single-mode fiber is input to the second single-mode fiber output and the second single-mode fiber is input to the first single-mode fiber output in the miniature three-fiber collimator can be realized.

By controlling the current direction of the coil, the above-mentioned two kinds of circular optical path switch switching functions can be realized, and the support of this kind of circular optical path switch switching can be provided for some applications.

In some embodiments, the three single-mode fibers in the three-hole capillary tube are arranged in order from top to bottom as the second single-mode fiber, the third single-mode fiber, and the first single-mode fiber.

In the magneto-optical switch of the present disclosure, the forward and reverse magnetic fields are generated by the current direction in the coil to control the forward and reverse of the optical rotation direction of the magneto-optical crystal, thereby realizing the switching of light beams at different ports. That is to say, the overall structure is stable and integrated, and there are no moving parts, which brings ultra-high channel switching repeatability to the magneto-optical switch and ultra-long life guarantee.

The polarization beam splitting prism in the magneto-optical switch of the present disclosure can decompose a beam of light of any polarization state into two beams of mutually perpendicular polarized light at a sufficiently small longitudinal distance, and generate a lateral separation distance of any size. Conversely, two beams of mutually perpendicular polarized lights can also be combined into one beam, which solves the contradiction between the long cross distance of the three-fiber fiber collimator and the larger the beam spot of the collimator as the distance is longer, so as to achieve small spot three-fiber collimation. The switch function of the straightener at a small crossing distance.

The actual implemented device can adopt a size similar to the following: the polarization beam splitting prism is 0.6 mm thick; the size of the micro spatial light processing optical core is controlled within 2.6 mm; the collimating lens has a spot diameter of 0.22 mm; and the three-fiber collimator has a cross distance controlled within 4-7mm. The total length of the collimator can be controlled within 12 mm, and the final length of the fiber switch device can be controlled within 18 mm. The lateral dimension of the fiber switch device can be controlled within 4.8 mm.

The miniature magneto-optical optical fiber switch of the present disclosure, by using a three-fiber collimator and a miniature spatial optical processing optical core, realizes a miniature magneto-optical fiber switch that can simultaneously have multiple switching operating modes, and has multiple operating modes, simple structure, and ultra-small volume, low insertion loss, low polarization-related loss, single-sided fiber output, ultra-high channel switching repeatability, and ultra-high lifetime.

### BRIEF DESCRIPTION OF THE DRAWINGS

FIG. 1 is a schematic diagram of the miniature magneto-optical according to the present disclosure.

FIG. 2 is a schematic diagram of the wave plate and magneto-optical crystal in the present disclosure changing the polarization state of the beam, that is, rotating 45° counterclockwise.

FIG. 3 is a schematic diagram of the wave plate and the magneto-optical crystal in the present disclosure changing the polarization state of the beam, that is, rotating 45° clockwise.

FIG. 4 is a schematic diagram of the optical path principle of light from the optical fiber 12 of the magneto-optical fiber switch to the optical fiber 11 in the present disclosure.

FIG. 5 is a schematic diagram of the optical path principle of light from the optical fiber 12 of the magneto-optical fiber switch to the optical fiber 13 in the present disclosure.

FIG. 6 is a schematic diagram of the optical path principle of light from the optical fiber 11 to the optical fiber 12 of the magneto-optical fiber switch in the present disclosure.

FIG. 7 is a schematic diagram of the optical path principle of light from the optical fiber 13 to the optical fiber 12 of the magneto-optical fiber switch in the present disclosure.

FIG. 8 is a schematic diagram of the circular optical path switching from each port to the optical path in the magneto-optical fiber switch of the present disclosure.

### DETAILED DESCRIPTION OF THE DISCLOSURE

In order to describe the present disclosure in more detail, the technical solution of the present disclosure will be described in detail below with reference to the accompanying drawings and specific embodiments.

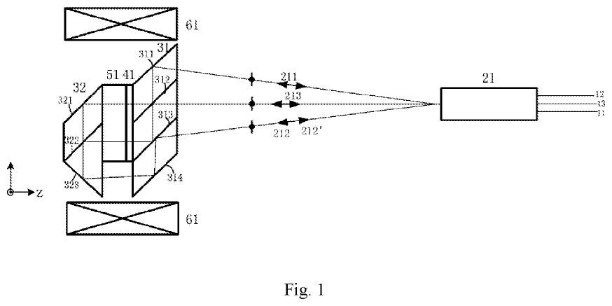

As shown in FIG. 1, the miniature magneto-optical fiber switch of the present disclosure includes a three-fiber collimator 21, a first polarization beam splitting prism 31, a wave plate 41, a magneto-optical crystal 51, a second polarization beam splitting prism 32, and a coil 61. Among them, the first polarization beam splitting prism 31, the wave plate 41, the magneto-optical crystal 51, and the second polarization beam splitting prism 32 are bonded and assembled through a micro-optics process to form the optical core of the magneto-optical switch. The first polarization beam splitting prism 31 in the optical core of the magneto-optical switch includes a first total reflection surface 311, a polarization beam splitting surface 312, a second total reflection surface 313, and a third total reflection surface 314. The second polarization beam splitting prism 32 includes a first total reflection surface 321, a polarization beam splitting surface 322 and a second total reflection surface 323.

The three-fiber collimator 21 includes a collimating lens, a three-hole capillary tube, optical fiber 11, optical fiber 12, and optical fiber 13. Among them, the optical fiber 11 is coupled into a collimated beam 211 by the collimating lens. The optical fiber 12 is coupled into a collimated beam 212 by the collimating lens. The optical fiber 13 is coupled by the collimating lens into a collimated beam 213. In order to distinguish the coupling input and output optical paths from the common fiber port in the cyclic optical path switching mode, the collimated beam corresponding to the output channel of the optical fiber 12 is 212, and the collimated beam corresponding to the input of the optical fiber 12 is 212′.

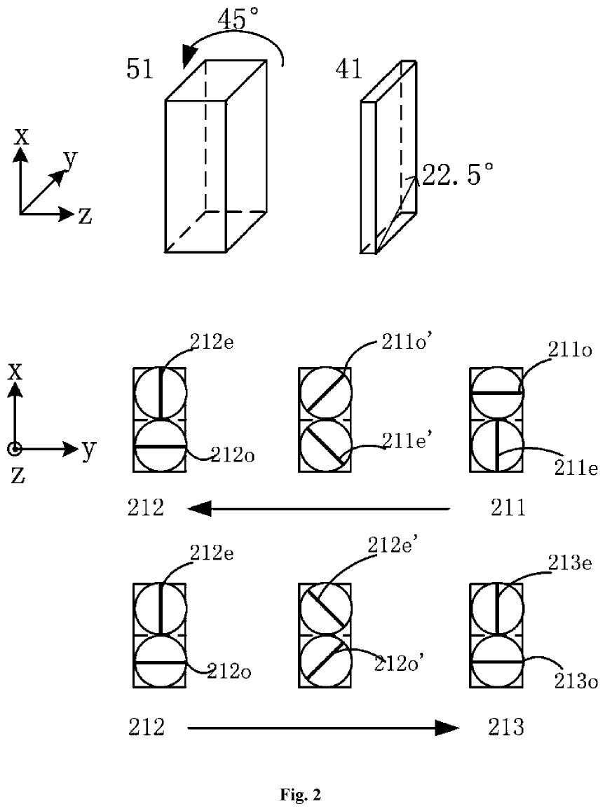

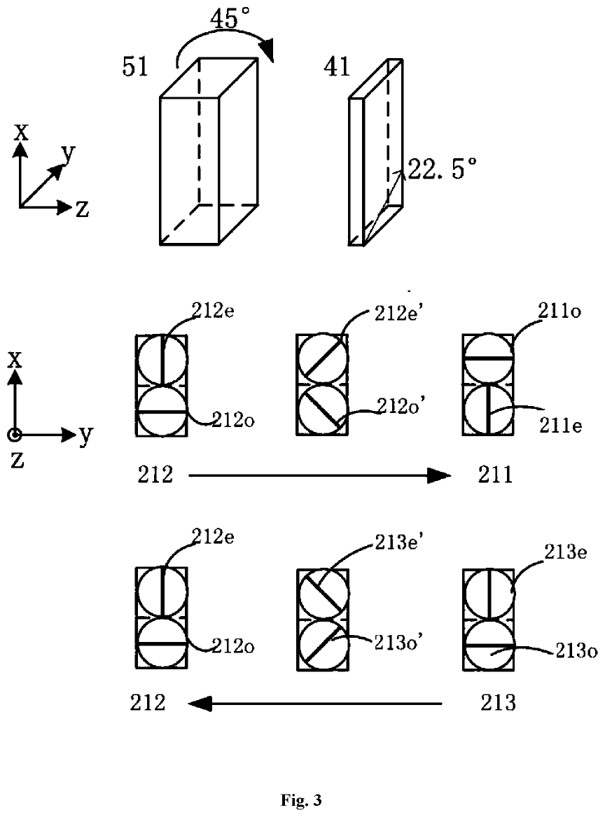

Referring to FIG. 1, FIG. 2 and FIG. 3, the wave plate and magneto-optical crystal of the micro magneto-optical fiber switch of the present disclosure change the polarization state of the beam, which is the polarization state deflection mechanism of the micro magneto-optical fiber switch of the present disclosure to realize the optical path switching.

Referring to FIG. 1, when the reverse current on the coil 61 (defining one of the directions as the forward and the other as the reverse direction), a reverse magnetic field is generated. At this time, the magneto-optical crystal 51 in the magnetic field of the coil 61 is rotated 45° (−45°) counterclockwise in the indicated direction of the figures. As shown in FIG. 2, the transmission direction is from the optical fiber 11→the optical fiber 12 direction, and the optical fiber 12→the optical fiber 13. The light beam incident from the optical fiber 11 is decomposed by the polarization beam splitting surface 312 of the first polarization beam splitting prism 31 into two mutually perpendicular polarized lights, that is, normal light and abnormal light. The polarization direction of normal light is along the y-axis direction, denoted as 211o. The polarization direction of the anomalous light is along the horizontal x-axis and is denoted as 211e. The two beams of light 2110 and 211e are rotated counterclockwise by the wave plate 41 to 45° (−45°), and their polarization directions are 45 degrees left and right, respectively, which are polarized lights 211o′ and 211e′. After the polarized lights 211o′ and 211e′ are rotated by −45° through the magneto-optical crystal 51, the 2110 light in the original y-axis direction becomes the x-axis polarization direction, and the original 211e light in the x-axis direction becomes the y-axis polarization direction. Then, the polarization beam splitting surface 322 of the second polarization beam splitting prism 32 is combined into the optical fiber 12 for output. It can be seen from FIG. 2 that propagating in the direction of fiber 12→fiber 13, the −45° rotation of the wave plate 41 and the −45° rotation of the magneto-optical crystal 51 are superimposed, so that the polarized light is rotated by 90°. As shown in FIG. 2, it is transmitted in the direction of optical fiber 12→optical fiber 13, and the light beam incident from optical fiber 12 is decomposed by polarization beam splitting surface 322 of second polarization beam splitting prism 32 into horizontal x-axis direction polarized light 212e and vertical y-axis direction polarized light 212o, the magneto-optical crystal 51 is rotated into the −45° direction to become polarized light 212e′ and 212o′, and then the wave plate 41 is rotated +45°, the original x-axis direction 212e light is still the x-axis direction polarized light. The original y-axis direction 212o light is still polarized light in the y-axis direction. And at last, the two light is combined by the polarization splitting surface 312 of the first polarization splitting prism 31 to the optical fiber 13 for output. It can be seen from FIG. 2 that propagating in the direction of fiber 12→fiber 13, the −45° rotation of the magneto-optical crystal 51 and the +45° rotation of the wave plate 41 are destructive, resulting in a 0° rotation of the polarized light.

Referring to FIG. 1, when the coil 61 passes a forward current, a positive (forward) magnetic field is generated. At this time, the magneto-optical crystal 51 in the magnetic field of the coil 61 rotates 45° (+45°) clockwise in the illustrated direction. As shown in FIG. 3, the analysis of the light beam propagating from the fiber 12→fiber 11 direction and from the fiber 13→fiber 12 direction, and the light beam incident from the fiber 12 is decomposed by the polarization splitting surface 322 of the second polarization beam splitting prism 32 into two mutually perpendicular polarized lights, namely normal light and abnormal light. The polarization direction of the anomalous light is along the horizontal x-axis and is denoted as 212e. The polarization direction of normal light is along the y-axis direction, denoted as 212o. The two beams of 212e and 212o are rotated by the magneto-optical crystal 51 into the +45° direction to become polarized lights 212e′ and 212o′, and then rotated by +45° through the wave plate 41, the original 212e light in the x-axis direction becomes polarized in the y-axis direction light, the original 212o light in the y-axis direction becomes polarized light in the x-axis direction, and at last the two lights are combined by the polarization beam splitting surface 312 of the first polarization beam splitting prism 31 to be output by the optical fiber 11. It can be seen from FIG. 3 that the +45° rotation of the magneto-optical crystal 51 and the +45° rotation of the wave plate 41 are superimposed when propagating in the direction of fiber 12→fiber 11, so that the polarized light is rotated by 90°. As shown in FIG. 3, propagating in the direction of optical fiber 13→optical fiber 12, the light beam incident from optical fiber 13 is decomposed by polarization beam splitting surface 312 of first polarization beam splitting prism 31 into horizontal x-axis direction polarized light 213e and vertical y-axis direction polarization light. The two beams of 213o, 213e and 213o are rotated counterclockwise by the wave plate 41 to 45° (+45°), and their polarization directions are 45 degrees left and right. They are polarized light 213e′ and 213o′ respectively, and then rotate +45 through the magneto-optical crystal 51°, the original 213e light in the x-axis direction is still the x-axis polarization direction, and the original y-axis direction 213e light is still the y-axis polarization direction, and then combined by the polarization splitting surface 322 of the second polarization splitting prism 32 to output the optical fiber 12. It can be seen from FIG. 3 that propagating in the direction of fiber 13→fiber 12, the −45° rotation of the wave plate 41 and the +45° rotation of the magneto-optical crystal 51 are destructive, resulting in a 0° rotation of the polarized light.

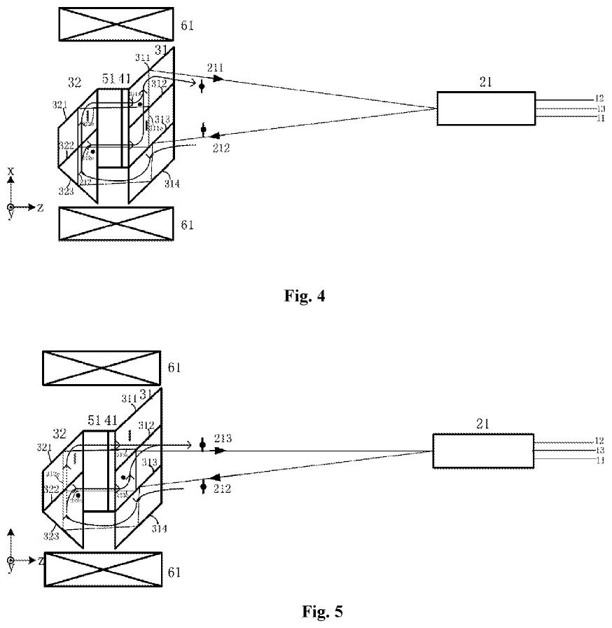

FIG. 4 and FIG. 5 illustrate the optical path of the micro-magneto-optical fiber in the 1×2 working mode of the present disclosure. FIG. 4 is a schematic diagram of the optical path of light from the optical fiber 12 of the magneto-optical switch to the optical fiber 11 when the coil 61 has the forward current to generate the positive magnetic field in the present disclosure. FIG. 5 is a schematic diagram of the optical path of light from the optical fiber 12→the optical fiber 13 of the magneto-optical switch when the reverse current is applied to the coil 61 to generate the reverse magnetic field in the present disclosure.

Referring to FIG. 4, the three-fiber collimator 21 collimates the light from the second single-mode fiber 12 into a parallel beam 212. The beam 212 is incident on the second total reflection surface 313 of the first polarization beam splitting prism 31, and then is reflected to the first polarization beam splitting prism 31. The third total reflection surface 314 of a polarization beam splitting prism 31 is then reflected on the second total reflection surface 323 of the second polarization beam splitting prism 32. The light beam 212 is reflected by the total reflection surface 323 and reaches the polarization beam splitting surface 322 of the second polarization beam splitting prism 32. After passing through the polarization beam splitting surface 322, the beam 212 is divided into two beams with mutually perpendicular polarization states, that is, the abnormal light 212e is along the horizontal x Axis direction, the normal light 212o is along the y-axis direction. The light beam 212o reaches the magneto-optical crystal 51 after being reflected by the polarization beam splitting surface 322. After the light beam 212o passes through the magneto-optical crystal 51, the polarization direction is rotated by +45°, which is denoted as 212o′. After passing through the wave plate 41, the polarization direction is rotated by +45°, and the original 212o light in the y-axis direction becomes the polarized light in the x-axis direction, which is denoted as 211e. The light beam 212e passes through the polarization splitting surface 322 and reaches the total reflection surface 321 of the second polarization splitting prism 32 and reaches the magneto-optical crystal 51 after being reflected by the total reflection surface 321. After the beam 212e passes through the magneto-optical crystal 51, the polarization direction is rotated by +45°, which is denoted as 212e′, and then the polarization direction of the wave plate 41 is rotated by +45°, and the original 212e light in the x-axis direction becomes the polarized light in the y-axis direction. 211o. The xy plane cross-sectional icon at the bottom of FIG. 3 shows the polarization state change of the light beams 212o and 212e from the optical fiber 12→the optical fiber 11 to the light beams 211e and 211o. After the light beam 211e reaches the first polarization splitting prism 31, it is reflected by the total reflection surface 313 of the first polarization splitting prism 31 and reaches the polarization splitting surface 312 of the first polarization splitting prism 31, and the light beam 2110 also reaches the polarization of the first polarization splitting prism 31. Splitting surface 312. The polarization beam splitting surface 312 of the first polarization beam splitting prism 31 combines the two beams into one beam, the combined beam is 211, and the combined beam 211 is received and output by the third single-mode fiber 11 of the first collimator 21.

By controlling the current direction of the coil, the Faraday rotation direction) (+45°) and the reverse direction (−45°) of the magneto-optical crystal can be switched, and the second single-mode fiber 12 in the three-fiber collimator can be selectively realized. Input to the switching of the output of the first single-mode fiber 11 (12→11) or the output of the third single-mode fiber (12→13) to realize the optical path structure of the 1×2 fiber switch.

When the coil 61 passes the reverse current to generate the reverse magnetic field, refer to FIG. 5, which is a schematic diagram of the optical path of light from the optical fiber 12 to the optical fiber 13 of the magneto-optical switch. After the optical fiber 212 is split by the polarization splitting surface 322 of the second polarization splitting prism 32, the light beam 2110 is reflected by the polarization splitting surface 322 and after passing through the magneto-optical crystal 51, the polarization direction is rotated −45°, denoted as 212o′, and then passes through the wave plate The polarization direction of 41 is rotated by +45° again, and the original 212o light in the y-axis direction is still polarized light in the y-axis direction, which is denoted as 213o. The light beam 212e is transmitted through the polarization beam splitting surface 322 and then reaches the first total reflection surface 321 of the second polarization beam splitting prism 32 and is reflected to reach the magneto-optical crystal 51. After the beam 212e passes through the magneto-optical crystal 51, the polarization direction is rotated −45°, which is denoted as 212e′, and then the polarization direction of the wave plate 41 is rotated again by +45°, and the original x-axis direction 212e light is still the x-axis direction polarized light 213e. The xy plane cross-sectional icon at the bottom of FIG. 2 shows the polarization state changes of the light beams 212o and 212e from the fiber 12→the fiber 13 to the light beams 213o and 213e. After the light beam 213o reaches the first polarization beam splitting prism 31, after being reflected by the total reflection surface 313 of the first polarization beam splitting prism 31, it reaches the polarization beam splitting surface 312 of the first polarization beam splitting prism 31, and the light beam 213e also reaches the polarization of the first polarization beam splitting prism 31. Splitting surface 312. The polarization beam splitting surface 312 of the first polarization beam splitting prism 31 combines the two beams into one beam, the combined beam is 213, and the combined beam 213 is received and output by the third single-mode fiber 13 of the first collimator 21.

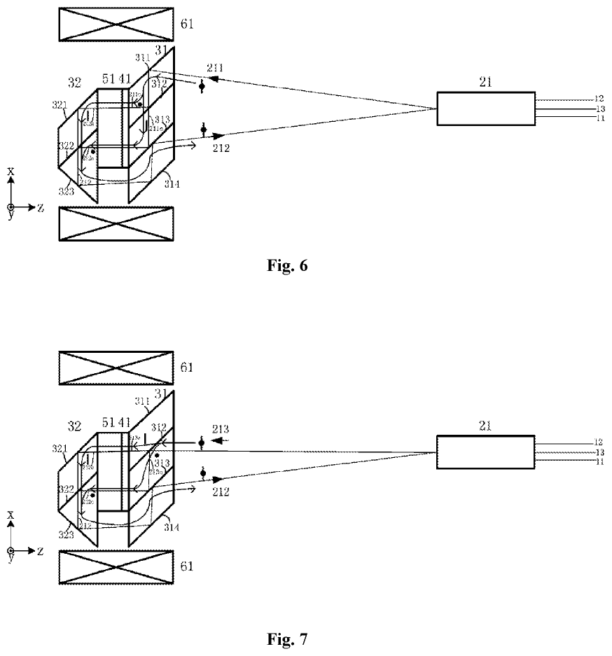

FIG. 6 and FIG. 7 are the optical path descriptions of the 2×1 working mode of the micro magneto-optical fiber of the present disclosure. 6 is a schematic diagram of the optical path principle of light from the optical fiber 11→the optical fiber 12 of the magneto-optical switch when the reverse current is applied to the coil 61 to generate the reverse magnetic field in the present disclosure. FIG. 7 is a schematic diagram of the optical path principle of the light from the optical fiber 13→the optical fiber 12 of the magneto-optical switch when the coil 61 passes the forward current to generate the positive magnetic field in the present disclosure.

Referring to FIG. 6, when a reverse current is applied to the coil 61 to generate a reverse magnetic field, the three-fiber collimator 21 collimates the light from the first single-mode fiber 11 into a parallel beam 211. After the light beam 211 is incident on the total reflection surface 311 of the first polarization beam splitting prism 31, it is reflected on the polarization beam splitting surface 312. After the light beam 211 passes through the polarization splitting surface 312, it is divided into two beams of light having mutually perpendicular polarization states, that is, the normal light 2110 and the abnormal light 211e. The polarization direction of the light beam 2110 is along the y-axis direction, and the polarization direction of the light beam 211e is along the x-axis direction. The light beam 2110 reaches the wave plate 41 after being reflected by the polarization beam splitting surface 312. After the light beam 2110 passes through the wave plate 41, the polarization direction is rotated by) 45° (−45°) counterclockwise, which is recorded as 211o′. After passing through the magneto-optical crystal 51, the polarization direction is rotated by 45° (−45°) counterclockwise, and the polarization direction of the 2110 light in the original y-direction becomes along the x-axis direction, which is recorded as 212e. The light beam 211e passes through the polarization beam splitting surface 312 and reaches the total reflection surface 313. After being reflected by the total reflection surface 313, it reaches the wave plate 41, and the polarization direction of the wave plate 41 is rotated by −45°, which is recorded as the beam 211e′. After passing through the magneto-optical crystal 51, the polarization direction is rotated again by −45°, and the polarization direction of the 211e light in the original x-direction becomes along the y-axis direction, which is recorded as 212o. The xy plane cross-sectional icon at the bottom of FIG. 2 shows the polarization state changes of the light beams 2110 and 211e from the optical fiber 11→the optical fiber 12 to the light beams 212e and 212o. After the light beam 212e reaches the second polarization beam splitting prism 32, it is reflected by the first total reflection surface 321 of the second polarization beam splitting prism 32 and then reaches the polarization beam splitting surface 322. The light beam 212o also reaches the polarization beam splitting surface 322 of the second polarization beam splitting prism 32. The polarization beam splitting surface 322 of the second polarization beam splitting prism 32 combines the two beams of light into one beam. The combined light beam is 212, which is reflected by the second total reflection surface 323 of the second polarization beam splitting prism 32 and reaches the third total reflection surface 314 of the first polarization beam splitting prism 31, and then passes through the second total reflection surface of the first polarization beam splitting prism 31 After 313 is reflected, the second single-mode fiber 12 of the dual-fiber collimator 21 receives the output.

Referring to FIG. 7, when the coil 61 generates a positive magnetic field with a forward current, the three-fiber collimator 21 collimates the light from the third single-mode fiber 13 into a parallel beam 213, and the beam 213 is incident on the polarization beam splitting surface 312 of the first polarization beam splitting prism 31. After the light beam 213 passes through the polarization splitting surface 312, it is divided into two light beams with mutually perpendicular polarization states, that is, the normal light 213o and the abnormal light 213e. The polarization direction of the light beam 213o is along the y-axis direction, and the polarization direction of the light beam 213e is along the x-axis direction. The light beam 213o is reflected by the polarization beam splitting surface 312 and then reflected by the second total reflection surface 313 of the first polarization beam splitter before reaching the wave plate 41. The beam 213o is rotated by 45° (−45°) counterclockwise through the polarization direction of the wave plate, which is recorded as 213o′. After the light beam 213o′ passes through the magneto-optical crystal 51, the polarization direction is rotated counterclockwise by +45°, and the original y-direction 213o light polarization direction is still along the y-axis direction, which is recorded as 212o. The light beam 213e is transmitted through the polarization beam splitting surface 312 and reaches the wave plate 41, and the polarization direction of the wave plate 41 is rotated by 31 45°, which is recorded as the light beam 213e′. After passing through the magneto-optical crystal 51, the polarization direction is rotated by +45°, and the original x-direction 213e light polarization direction is still along the x-axis direction 212e. The xy plane cross-sectional icon at the bottom of FIG. 3 shows the polarization state changes of the light beams 213o and 213e from the fiber 13→the fiber 12 to the light beams 212o and 212e. After 212e reaches the second polarization beam splitting prism 32, it is reflected by the first total reflection surface 321 of the second polarization beam splitting prism 32 and then reaches the polarization beam splitting surface 322. The light beam 212o also reaches the polarization beam splitting surface 322 of the second polarization beam splitting prism 32. The polarization beam splitting surface 322 of the second polarization beam splitting prism 32 combines the two beams of light into one beam. The combined light beam is 212, which is reflected by the second total reflection surface 323 of the second polarization beam splitting prism 32 and reaches the third total reflection surface 314 of the first polarization beam splitting prism 31, and then passes through the second total reflection surface 313 of the first polarization beam splitting prism 31 After being reflected by the second total reflection surface 313, the second single-mode fiber 12 of the dual-fiber collimator 21 receives and outputs the combined light beam 212.

By controlling the direction of the coil current, the Faraday rotation of the magneto-optical crystal can be switched between the forward 45° and the reverse (−45°), so as to select the first fiber 11 and the third fiber 13 to switch to the second single-mode fiber 12 output The optical path structure of the 2×1 optical fiber switch (optical fiber 11→optical fiber 12 or optical fiber 13→optical fiber 12).

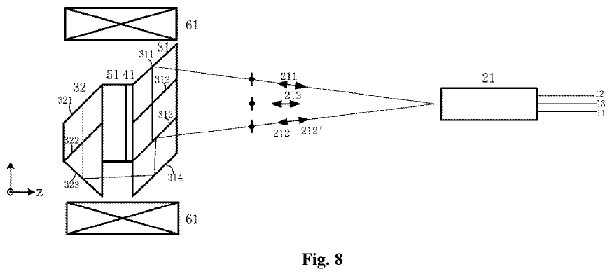

Referring to FIG. 8, the miniature magneto-optical fiber switch of the present disclosure provides two working modes of cyclic optical switch switching, and its working mode is as follows: When the direction of the magnetic field generated by the current control coil makes the polarization direction generated by the magneto- optical crystal rotate 45° counterclockwise (−45°), the polarization rotation +45° and −45° generated by the two light transmission directions in the wave plate are destructive or superimposed. In this way, in the three-fiber collimator, the first single-mode fiber 11 is input to the second single-mode fiber 12 output (beam 211→212′), and the second single-mode fiber 12 is input to the third single-mode fiber 13 output (Light beam 212→213) circular light path conduction mode.

When the direction of the magnetic field generated by the current control coil makes the polarization direction generated by the magneto-optical crystal rotate 45° (+45°) clockwise, the polarization generated by the two optical transmission directions in the wave plate is rotated by +45° and −45° to produce polarization The superimposition or cancellation of rotation is realized in the three-fiber collimator from the input of the third single-mode fiber 13 to the output of the second single-mode fiber 12 (beam 213→212′), and the input of the second single-mode fiber 12 to the first The circular optical path conduction mode of the single-mode fiber 11 output (beam 212→211).

By controlling the direction of the current coil, the above-mentioned two kinds of circular optical path switch switching functions can be realized, and the support of this kind of circular optical path switch switching can be provided for some applications.

The above description of the embodiments is to facilitate those of ordinary skill in the art to understand and apply the present disclosure. It is obvious that those skilled in the art can easily make various modifications to the above-mentioned embodiments, and apply the general principles described here to other embodiments without creative efforts. Therefore, the present disclosure is not limited to the above-mentioned embodiments. According to the disclosure of the present disclosure, the improvements and modifications made to the present disclosure by those skilled in the art are within the scope of the present disclosure.

What is claimed is:

1. A miniature magneto-optical fiber switch, comprising:
a miniature three-fiber collimator,
a miniature current coil, and
a miniature space optical processing optical core;
the miniature magneto-optical optical fiber switch realizes a 1×2 optical fiber switch structure and a 2×1 optical fiber switch structure by controlling the current direction of the coil; wherein,
the miniature three-fiber collimator is assembled by bonding a three-hole capillary tube, three single-mode fibers and a collimating microlens through a micro-optics process; the three holes of the three-hole capillary tube are uniformly arranged in a line; the three single-mode fibers are respectively placed in the three-hole capillary tube, and spacings between the three single-mode fibers are uniform; the collimating microlens collimates the input light of the three single-mode fibers into three directions in space, and realizes the even collimated spatial light angle of the three single-mode fibers in the miniature three-fiber collimator through micro-optics adjustment and bonding assembly;
the miniature current coil generates a spatial saturation magnetic field under the action of current, and the spatial orientation of the magnetic field is parallel to the axis of the coil;
the micro spatial light processing optical core is assembled by a first polarization beam splitting prism, a wave plate, a magneto-optical crystal, and a second polarization beam splitting prism through micro-optical bonding; the first polarization beam splitting prism sequentially comprises a first total reflection surface, a polarization beam splitting surface, a second total reflection surface, and a third total reflection surface; the second polarization beam splitting prism sequentially comprises a first total reflection surface, a polarization beam splitting surface, and a second total reflection surface; the wave plate combined with the magneto-optical crystal is used to change the polarization state of the beam;
the optical axis orientation of the wave plate is 22.5° with the horizontal direction of the light transmission tangent plane, thereby realizing a 45° rotation of the input horizontally polarized light and a 135° polarization rotation of the input vertical polarized light; or, the optical axis orientation of the wave plate is 22.5° to the vertical direction of the light transmission tangent plane, thereby realizing a 45° rotation of the input vertically polarized light and a 135° polarization rotation of the input horizontally polarized light;
the magneto-optical crystal is a Faraday rotator crystal with an coercive force of the internal magnetic field; the direction of the coercive force of the internal magnetic field is parallel to the direction of the spatial saturation magnetic field generated by the miniature current coil; the coercive force of the internal magnetic field of the magneto-optical crystal makes the input linearly polarized light produce a polarization state of 45° or −45°, and the direction of the coercive force of the internal magnetic field is parallel to the light transmission direction;
under the spatial saturation magnetic field generated by the miniature current coil, when the direction of the magnetic field is opposite to the direction of the coercive force, the coercive force of the internal magnetic field of the magneto-optical crystal will be reversed; the reversal of the coercive force causes the direction of the Faraday rotation to be reversed; that is, the Faraday rotation angle of linearly polarized light is changed from 45° to −45° or from −45° to 45°.

2. The miniature magneto-optical fiber switch according to claim 1, wherein the miniature magneto-optical fiber switch realizes the switching of the direction of the spatial saturation magnetic field by changing the direction of the coil current, and then controls the forward and reverse of the rotation direction of the magneto-optical crystal to realize the switching of the light beam conduction channel at different fiber ports.

3. The miniature magneto-optical fiber switch according to claim 1, wherein the optical path of the micro-magneto-optical fiber switch with a 1×2 fiber-optic switch structure is realized as: when the magnetic field generated by the current control coil makes the polarization direction generated by the magneto-optical crystal rotating 45° clockwise (that is, forward +45°), the collimating microlens collimates the light from the second single-mode fiber into a parallel beam, which passes through the second total reflection surface of the first polarization beam splitting prism, the third total reflection surface of the first polarization beam splitting prism, and the first polarization beam splitting prism in turn; the second total reflection surface of the two polarization beam splitting prism reaches the polarization beam splitting surface of the second polarization beam splitting prism after reflection; the fully polarized light beam is divided into two light beams with mutually perpendicular polarization states after passing through the polarization beam splitting surface, that is, the normal light beam and the abnormal light beam; the polarization direction of the normal light beam is along the vertical y-axis direction, and the polarization direction of the abnormal light beam is along the horizontal x-axis direction; the normal beam reaches the magneto-optical crystal after being reflected by the polarization splitting surface of the second polarization beam splitting prism for 90 degrees; after the polarization direction of the magneto-optical crystal is rotated by +45°, the polarization direction of the wave plate is rotated clockwise by 45°, and the polarization direction of the normal beam is changed to the horizontal x-axis direction; the abnormal light beam is transmitted through the polarization beam splitting surface of the second polarization beam splitting prism and reflected by the first total reflection surface of the second polarization beam splitting prism to reach the magneto-optical crystal; the polarization direction is rotated 45° clockwise, and the polarization state of the abnormal beam becomes vertical to the y-axis direction; the normal light beam passing through the wave plate is reflected by the second total reflection surface of the first polarization beam splitting prism and reaches the polarization beam splitting surface of the first polarization beam splitting prism, which becomes an abnormal beam relative to the polarization beam splitting surface of the first polarization beam splitting prism; however, the abnormal light beam passing through the wave plate reaches the first polarization beam splitting prism, and it becomes a normal beam relative to the polarization beam splitting surface of the first polarization beam splitting prism; the polarization beam splitting surface of the first polarization beam splitting prism combines the two beams into one beam, and the combined beam passes through the first total reflection surface of the first polarization beam splitting prism and is received and output by the first single-mode fiber in the micro three-fiber collimator;
when the magnetic field generated by the current control coil makes the polarization direction generated by the magneto-optical crystal rotate 45° counterclockwise (that is, reverse −45°), the collimating microlens collimates the light from the second single-mode fiber into a parallel beam, After being reflected by the second total reflection surface of the first polarization beam splitting prism, the third total reflection surface of the first polarization beam splitting prism, and the second total reflection surface of the second polarization beam splitting prism in turn, it reaches the polarization beam splitting surface of the second polarization beam splitting prism; the fully polarized light beam is divided into two light beams with mutually perpendicular polarization states after passing through the polarization beam splitting surface, that is, the normal light beam and the abnormal light beam; the polarization direction of the normal light beam is along the vertical y-axis direction, and the polarization direction of the abnormal light beam is along the horizontal x-axis direction; the normal beam reaches the magneto-optical crystal after being reflected by the polarization splitting surface of the second polarization beam splitting prism for 90 degrees; after the polarization direction of the magneto-optical crystal is rotated by −45°, the polarization direction of the wave plate is rotated clockwise by 45°; the polarization state of the normal beam is There is no change, and the polarization direction is still along the vertical y-axis; the abnormal light beam is transmitted through the polarization beam splitting surface of the second polarization beam splitting prism and reflected by the first total reflection surface of the second polarization beam splitting prism to reach the magneto-optical crystal; the polarization direction is rotated 45° clockwise, and the polarization state of the abnormal beam remains unchanged, and its polarization direction is still along the horizontal x-axis direction; the normal light beam passing through the wave plate is reflected by the second total reflection surface of the first polarization beam splitting prism and reaches the polarization beam splitting surface of the first polarization beam splitting prism; the abnormal beam output by the wave plate is polarized and combined on the polarization beam splitting surface, and the polarization beam is split; the two beams are polarized and combined into one beam, and the combined beam is received and output by the third single-mode fiber of the miniature three-fiber collimator;
by controlling the current direction of the coil, the Faraday rotation direction of the magneto-optical crystal can be switched forward or reverse, and then the second single-mode fiber in the micro three-fiber collimator can be selectively input to the first single-mode fiber output or the second single-mode fiber output; switching between the input of the mode fiber and the output of the third single mode fiber, thereby realizing a 1×2 fiber switch structure.

4. The miniature magneto-optical fiber switch according to claim 1, wherein the optical path of the miniature magneto-optical fiber switch with a 2×1 fiber switch structure is realized as: when the magnetic field generated by the current control coil makes the polarization direction generated by the magneto-optical crystal rotate 45° counterclockwise (that is, reverse −45°)°), the collimating microlens collimates the light from the first single-mode fiber into a parallel beam, which is reflected by the first total reflection surface of the first polarization beam splitting prism and reaches the polarization beam splitting surface of the first polarization beam splitting prism;
the polarized light beam is divided into two light beams with mutually perpendicular polarization states after passing through the polarization beam splitting surface, that is, the normal light beam and the abnormal light beam; the polarization direction of the normal light beam is along the vertical y-axis direction, and the polarization direction of the abnormal light beam is along the horizontal x-axis direction; the normal light beam is reflected by the polarization beam splitting surface of the second polarization beam splitting prism and reaches the wave plate; after the polarization direction of the wave plate is rotated 45° counterclockwise, the polarization direction of the magneto-optical crystal is rotated −45°, and the polarization direction of the normal light beam becomes horizontal x-axis direction; then, the normal light beam is reflected by the first total reflection surface of the second polarization beam splitting prism and then reaches the polarization beam splitting surface of the second polarization beam splitting prism; abnormal light beams are transmitted through the polarization beam splitting surface of the second polarization beam splitting prism in turn, and then reflected by the second total reflection surface of the first polarization beam splitting prism to reach the wave plate; the polarization direction of the crystal is rotated −45°, and the polarization state of the abnormal beam becomes perpendicular to the y-axis direction and reaches the polarization splitting surface of the second polarization splitting prism; the polarization beam splitting surface of the second polarization beam splitting prism combines the two beams into one beam; the combined beam is sequentially reflected by the second total reflection surface of the second polarization beam splitting prism, the third total reflection surface of the first polarization beam splitting prism, and the second total reflection surface of the first polarization beam splitting prism, and is received and outputted by the second single-mode fiber in the miniature three-fiber collimator;
when the magnetic field generated by the current control coil makes the polarization direction generated by the magneto-optical crystal rotate 45° clockwise (that is, forward +45°), the collimating microlens collimates the light from the third single-mode fiber into a parallel beam, When incident on the polarization beam splitting surface of the first polarization beam splitting prism, the fully polarized light beam passes through the polarization beam splitting surface and is divided into two beams with mutually perpendicular polarization states, namely, the normal beam and the abnormal beam; the polarization direction of the normal light beam is along the vertical y-axis direction, and the polarization direction of the abnormal light beam is along the horizontal x-axis direction; the normal light beam is reflected by the polarization beam splitting surface of the first polarization beam splitting prism and the second total reflection surface of the first polarization beam splitting prism in turn, and then reaches the wave plate; when the direction is rotated by +45°, the polarization state of the normal beam remains unchanged, and the polarization direction is still along the vertical y-axis; then, the normal light beam reaches the polarization splitting surface of the second polarization splitting prism; the abnormal beam passes through the polarization splitting surface of the first polarization beam splitting prism and reaches the wave plate, and then the polarization direction of the wave plate is rotated 45° counterclockwise, and then the polarization direction of the magneto-optical crystal is rotated +45°; the polarization state of the abnormal beam remains unchanged; its polarization direction is still along the horizontal x-axis direction; then, the returning beam is reflected by the first total reflection surface of the second polarization beam splitting prism and then reaches the polarization beam splitting surface of the second polarization beam splitting prism; the polarization beam splitting surface of the second polarization beam splitting prism combines the two beams into one beam; the combined beams are sequentially reflected by the second total reflection surface of the second polarization beam splitting prism, the third total reflection surface of the first polarization beam splitting prism, and the second total reflection surface of the first polarization beam splitting prism, and are received and outputted by the second single-mode fiber in the miniature three-fiber collimator;
by controlling the current direction of the coil, the Faraday rotation of the magneto-optical crystal can be switched forward or reverse, and then the third single-mode fiber or the first single-mode fiber in the miniature three-fiber collimator can be selectively switched, thereby realizing a 2×1 fiber switch structure.

5. The miniature magneto-optical fiber switch according to claim 1, wherein when the direction of the magnetic field generated by the current control coil makes the polarization direction generated by the magneto-optical crystal rotate 45° counterclockwise, it corresponds to the polarization rotation of +45° and −45° generated by the two optical transmission directions in the wave plate; elimination and superposition, so as to realize the circular optical path conduction mode of the micro three-fiber collimator from the first single-mode fiber input to the second single-mode fiber output, and from the second single-mode fiber input to the third single-mode fiber output;
when the direction of the magnetic field generated by the current control coil makes the polarization direction generated by the magneto-optical crystal rotate 45° clockwise, it overlaps and cancels the polarization rotation +45° and −45° generated by the two light transmission directions in the wave plate; therefore, the circular optical path conduction mode in which the third single-mode fiber is input to the second single-mode fiber output and the second single-mode fiber is input to the first single-mode fiber output in the miniature three-fiber collimator can be realized;
by controlling the current direction of the coil, the above-mentioned two kinds of circular optical path switch switching functions can be realized, and the support of this kind of circular optical path switch switching can be provided for some applications.

6. The miniature magneto-optical fiber switch according to claim 3, wherein the three single-mode fibers in the three-hole capillary tube are arranged in order from top to bottom as the second single-mode fiber, the third single-mode fiber, and the first single-mode fiber.

7. The miniature magneto-optical fiber switch according to claim 4, wherein the three single-mode fibers in the three-hole capillary tube are arranged in order from top to bottom as the second single-mode fiber, the third single-mode fiber, and the first single-mode fiber.

8. The miniature magneto-optical fiber switch according to claim 5, wherein the three single-mode fibers in the three-hole capillary tube are arranged in order from top to bottom as the second single-mode fiber, the third single-mode fiber, and the first single-mode fiber.
